(19) United States
(12) Patent Application Publication
(10) Pub. No.: US 2022/0028298 A1
(43) Pub. Date: Jan. 27, 2022

(54) PRONUNCIATION TEACHING METHOD

(71) Applicant: National Taiwan University of Science and Technology, Taipei (TW)

(72) Inventor: Chyi-Yeu Lin, Taipei (TW)

(73) Assignee: National Taiwan University of Science and Technology, Taipei (TW)

(21) Appl. No.: 17/382,364

(22) Filed: Jul. 22, 2021

(30) Foreign Application Priority Data
Jul. 24, 2020 (TW) 109125051

(51) Int. Cl. G09B 19/04; G10L 15/22; G10L 15/26; H04L 12/58

(52) U.S. Cl. CPC G09B 19/04; G10L 15/22; G10L 2015/225; H04L 51/32; G10L 2015/221; G10L 15/26

(57) ABSTRACT

A pronunciation teaching method is provided. A service account is provided in a social communication program to provide a pronunciation teaching program. The service account provides guidance information to a user account which inputs the guidance information by voice input and directly transmits the guidance information to the service account by a text to be evaluated converted by a voice input engine. The service account provides an evaluation result to a corresponding user account according to the text to be evaluated. The social communication program provides the reception and transmission of text messages. The guidance information is texts provided for users to pronounce. The evaluation results are related to the difference between the guidance information and the text to be evaluated. Accordingly, the pronunciation defects of users can be effectively detected. Curative pronunciation exercises can be arranged specifically to improve the pronunciation accuracy of users and the efficiency of voice input.

### CROSS-REFERENCE TO RELATED APPLICATION

This application claims the priority benefit of Taiwanese application no. 109125051, filed on Jul. 24, 2020. The entirety of the above-mentioned patent application is hereby incorporated by reference herein and made a part of this specification.

### BACKGROUND

### Technology Field

The disclosure relates to a voice input technology, and particularly to a pronunciation teaching method.

### Description of Related Art

Social communication software (e.g., Line, WhatsApp, WeChat, Facebook Messenger, or Skype, or the like.) has gradually replaced telephone conversation and become a chat tool widely used by modern people. In some cases, if a user cannot directly talk to the other party, most social communication software can also provide message transmission functions. However, for the elderly or those with inconvenient hands, typing on the keyboard is a very difficult or even impossible task. With the maturity of voice recognition technology, the operating systems (e.g., Windows, MacOS, iOS, Android, or the like) of personal communication devices (e.g., computers, mobile phones, and the like) commonly used by people have built-in voice input tools and allow users to speak instead of physical or virtual keyboard typing to improve the efficiency of text input.

Note that the voice input method is quite mature technology, but factors, such as education and growth environment may affect a user's pronunciation and make the text recognized by the voice input tool different from what the user intended to pronounce. No matter the user speaks his/her native language or a foreign language, if there are too many errors, it may take the user extra time to correct them, which is a waste of time. Moreover, it is a pity that users are often not aware of the pronunciation errors and have no idea about how to do self-learning and correction, so the accuracy of pronunciation cannot be effectively improved. In an era when more and more people rely on voice input tools for various types of communication, if there is a convenient pronunciation teaching method that requires no human involvement, users who are interested in improving the pronunciation accuracy of various languages can acquire their learning to improve their pronunciation at any time. After the pronunciation gets more accurate, when using personal communication devices, the users can not only use the voice input tools in a faster and more effective manner but also can have more effective face-to-face verbal communication even if they are chatting with real people because of the more accurate pronunciation.

### SUMMARY

In view of this, the embodiments of the disclosure provide a pronunciation teaching method to assist in analyzing wrong content and therefore to provide learning or correction assistance.

The pronunciation teaching method of the embodiment of the disclosure includes steps as follows. A service account is provided in a social communication program, and a pronunciation teaching program is provided through the service account. The pronunciation teaching program includes steps as follows. Guidance information is provided to user accounts through the service account. The guidance information is input by voice input through the user accounts, and a text to be evaluated converted from the guidance information through a voice input engine is directly transmitted to the service account. An evaluation result is provided to a corresponding user account according to the text to be evaluated through the service account. The social communication program provides reception and transmission of text messages, the guidance information is a text provided for users to pronounce, and the evaluation result is related to a difference between the guidance information and the text to be evaluated.

In summary, the pronunciation teaching method of the embodiment of the disclosure provides a voice learning robot (i.e., a service account) in a social communication program, analyzes content converted by a voice input engine, and accordingly provides services, such as error analysis, pronunciation training, content correction, or the like. Therefore, the user can acquire correct pronunciation, learning becomes convenient, and thereby both the efficiency of voice input and the accuracy of the pronunciation are improved.

In order to make the aforementioned features and advantages of the disclosure comprehensible, embodiments accompanied with drawings are described in detail below.

### BRIEF DESCRIPTION OF THE DRAWINGS

FIG. 1 is a schematic view of a system according to an embodiment of the disclosure.

FIG. 2 is a flowchart of a pronunciation teaching method according to an embodiment of the disclosure.

FIG. 3A and FIG. 3B are an example illustrating a user interface of a social communication program.

### DESCRIPTION OF THE EMBODIMENTS

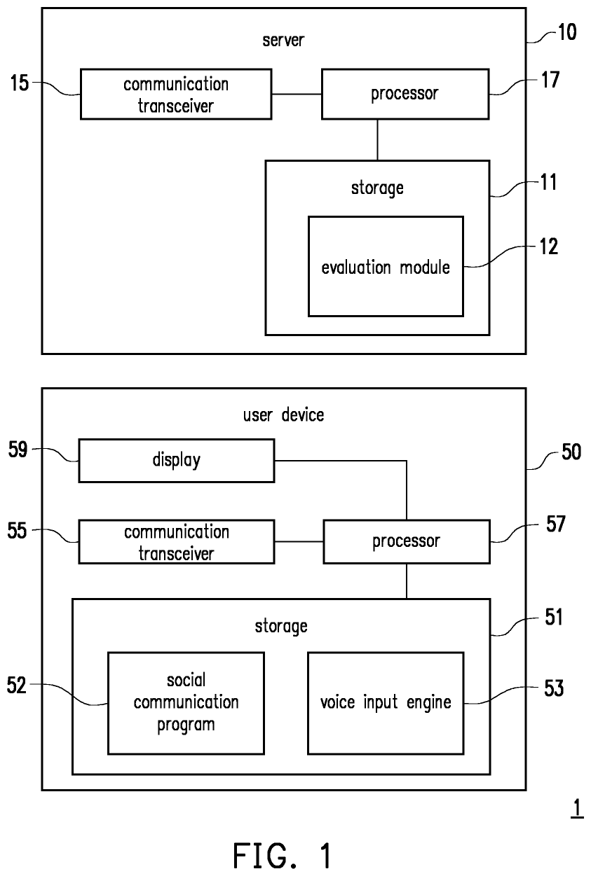

FIG. 1 is a schematic view of a system 1 according to an embodiment of the disclosure. Referring to FIG. 1, the system 1 includes but is not limited to a server 10 and one or more user devices 50.

The server 10 may be various types of electronic devices, such as servers, workstations, backend hosts, or personal computers. The server 10 includes but is not limited to a storage 11, a communication transceiver 15, and a processor 17.

The storage 11 can be any type of fixed or removable random access memory (RAM), read only memory (ROM), flash memory, traditional hard disk drives (HDDs), solid-state drives (SSDs), or the like. Moreover, the storage 11 is used to store the software module (e.g., an evaluation module 12) and the code thereof, as well as other temporary or permanent data or files. The details of which are illustrated in the subsequent embodiments.

The communication transceiver 15 may be a transmitting and receiving circuit that supports communication technologies such as Wi-Fi, mobile network, optical fiber network, and Ethernet. Moreover, the communication transceiver 15 is used to mutually transmit or receive signals with external devices.

The processor 17 may be an operation unit, such as a central processing unit (CPU), a graphics processing unit (GPU), a micro control unit (MCU), or an application-specific integrated circuit (ASIC). The processor 17 is used to execute all operations of the server 10 and can load and execute the evaluation module 12. The detailed operation of which is illustrated in the subsequent embodiments.

The user device 50 may be an electronic device, such as a smart phone, a tablet, a desktop computer, a laptop computer, a smart TV, or a smart watch. The user device 50 includes but is not limited to a storage 51, a communication transceiver 55, a processor 57, and a display 59.

The implementation modes of the storage 51, the communication transceiver 55, and the processor 57 can refer to the descriptions of the storage 11, the communication transceiver 15 and the processor 17, respectively, which is not iterated herein.

Moreover, the storage 51 is used to store software modules (e.g., a social communication program 52, such as Line, WhatsApp, WeChat, Facebook Messenger, Skype, or the like; a voice input engine 53, such as a voice input method, third-party speech-to-text tools, or the like built in the operating system of the user device 50—Windows, MacOS, iOS, Android, or the like) and the code thereof. The processor 57 is used to execute all operations of the user device 50. The processor 57 can load and execute the social communication program 52 and the voice input engine 53, and the detailed operation of which is illustrated in the subsequent embodiments.

The display 59 may be an LCD display, LED display, or OLED display. The display 59 is used for presenting a video image or a user interface.

In the subsequent paragraphs, with reference to various devices, components, and modules in the system 1, the method of the embodiment of the disclosure is illustrated. Each process of the method can be adjusted accordingly according to the implementation situation, but the disclosure is not limited thereto.

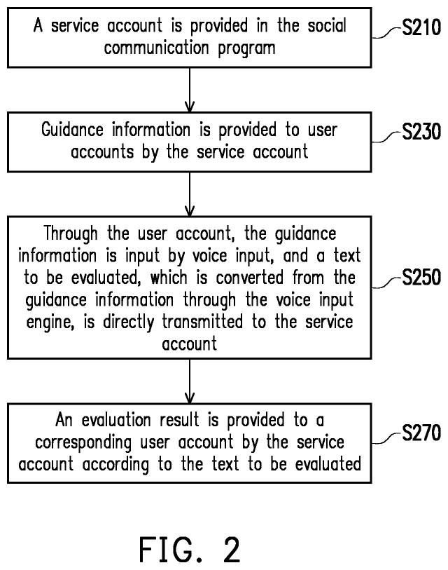

FIG. 2 is a flowchart of a pronunciation teaching method according to an embodiment of the disclosure. Referring to FIG. 2, a service account is provided in the social communication program 52 (step S210). Specifically, the social communication program 52 can provide a text input and generate text messages according to an input of the user. The reception and transmission of the text messages are further provided through the communication transceiver 55.

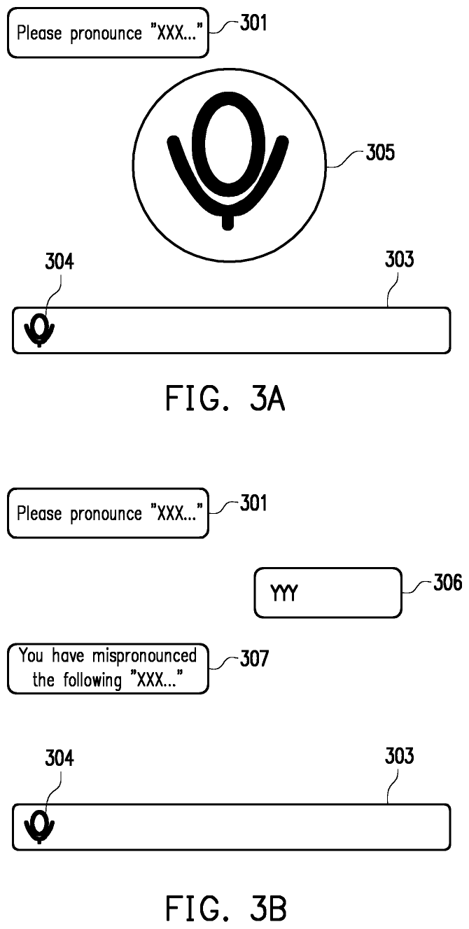

For example, FIG. 3A and FIG. 3B are an example illustrating the user interface of the social communication program 52. Referring to FIG. 3A, the user interface provides a text input field 303. After the user clicks the text input field 303, the user can input texts through a virtual or physical keyboard. After the user presses “Enter” or other physical or virtual sending buttons, the text content in the text input field 303 may be used as a text message and sent out through the communication transceiver 15. On the other hand, text messages sent by other accounts of the social communication program 52 can also be presented on the user interface of the social communication program 52 through the display 59. Taking FIG. 3A as an example, the message 301 is a text message sent by another account.

Note that the server 10 of the embodiment of the disclosure can provide a voice input learning robot (run by the evaluation module 12). This robot is one of the service accounts belonging to the social communication program 52 (hereinafter referred to as a service account), and any user device 50 can use its user account on the social communication program 52 to join this service account or directly transmit or receive messages to the service account. Moreover, the service account provides a pronunciation teaching program. This pronunciation teaching program refers to providing education and learning correction services for the content pronounced by the user account, which is illustrated in detail in the subsequent paragraphs.

In the pronunciation teaching program, the service account is generated through the evaluation module 12 and provides several user accounts of the social communication program with guidance information (step S230). Specifically, the guide information is a text for the user of the user account to pronounce. The guidance information may be text data designed to facilitate subsequent pronunciation correctness analysis (e.g., words and sentences including some or all vowels and finals) or may be content such as advertising lines, verses, or articles. Moreover, the language of the guidance information may be selected by the user or preset by the server 10.

In one embodiment, the service account can directly transmit guidance information to one or more user accounts through a social communication program. That is, the content of the text message is the actual content of the guidance information. For example, the message 301 in FIG. 3A is “Please read XXX”.

In another embodiment, unique identification codes are set to correspond to several pieces of guidance information according to their country, context, type, and/or length. For example, an identification code E1 is an English verse, and an identification code C2 is an advertisement line in Mandarin. The service account can transmit an identification code corresponding to the guidance information to the user account through the social communication program. The user of the user account can obtain the corresponding guidance information in a specific webpage, an application, or a database through the user device 50 according to the received identification code.

After obtaining the guidance information, the processor 57 of the user device 50 can display the guidance information generated by the server 10 on the display 59 for the user of the user account to read. Taking FIG. 3A as an example, the message 301 is the guidance information transmitted by the server 10. The guidance information is to ask the user of the user account to pronounce a specific text.

The user of the user account inputs the guidance information by voice input, and the user device 50 can record the voice content that the user pronounces according to the guidance information and convert the pronounced guidance information into a text to be evaluated through the voice input engine 53 to be directly transmitted to the service account (step S250). Specifically, a voice input engine 53 is built in the user device 50. The user can select or preset the voice input engine 53 in the system to convert the typing input mode into the voice input mode. The voice input engine 53 is mainly according to voice recognition technology (e.g., technologies such as signal processing, feature extraction, acoustic model, pronunciation dictionary, decoding, or the like) to convert voice into text. Taking FIG. 3A as an example, after the user clicks the voice input button 304 (taking the microphone pattern as an example), the user interface further presents a voice input prompt 305 to allow the user to know that the social communication program 52 has entered the voice input mode. The voice input engine 53 can convert the voice content pronounced by the user of the user account into a text and present it on the text input field 303 through the display 59. That is, according to the foregoing description regarding the content that the voice input engine 53 converts the voice into a text, the text to be evaluated in the form of text is generated. Note that the text to be evaluated is the text content directly recognized by the voice input engine 53 and has not been further corrected by the user. If the text content directly recognized by the voice input engine 53 is different from the text content originally intended to be pronounced by the user, it means that the voice pronounced according to the text content originally intended to be pronounced is not accurate enough to be correctly understood by the voice input engine 53. Moreover, the user does not need to compare the text to be evaluated and the guidance information by himself, and the processor 57 can directly transmit the text to be evaluated to the service account through the social communication program 52 and through the communication transceiver 55.

On the other hand, the processor 17 (of the service account) receives the text to be evaluated through the communication transceiver 15, and the service account can provide a corresponding user account with an evaluation result according to the text to be evaluated (step S270). Specifically, the processor 17 can generate the evaluation result according to the difference between the guidance information and the text to be evaluated. That is, the evaluation result is related to the difference between the guidance information and the text to be evaluated (e.g., the difference in pronunciation or text, or the like). In one embodiment, the evaluation module 12 can compare the guidance information with the text to be evaluated to obtain wrong content in the text to be evaluated. That is, the wrong content is the difference in text between the guidance information and the text to be evaluated. For example, if the guidance information is “It is sunny and cloudy with occasional showers”, the text to be evaluated is “Its sounding and cloudy with occasional showers”, and the wrong content is “its sounding”.

In one embodiment, the evaluation module 12 (of the service account) can generate an evaluation result according to at least one of the text or the pronunciation in the wrong content. For example, the evaluation result is a statistical result of the text or pronunciation in the wrong content. For example, each word and/or each pronunciation in the wrong content and its statistical number. The evaluation result can be an error report of the statistical result and can also be a list of incorrectly pronounced words and/or finals, vowels, or consonants. In another embodiment, the evaluation module 12 can evaluate the wrong content. For example, the percentage of the entire content that the wrong content accounts for, or the degree to which normal people understand the content. In some embodiments, the evaluation module 12 may further obtain corresponding correct and wrong pronunciations according to the text in the wrong content to add the content of the evaluation result.

The evaluation module 12 (of the service account) can transmit the evaluation result (as a text message, or other types of files such as pictures, text files, or the like) through the communication transceiver 15 and the processor 57 (of the user account) can receive the evaluation result through the communication transceiver 55 and through the social communication program 52. The processor 57 can further display the evaluation result on the display 59, so that the user of the user account can be instantly aware of the wrong pronunciation. Taking FIG. 3B as an example, the message 306 is the text to be evaluated obtained by the voice input engine 53 converting the voice content pronounced by the user, and the message 307 is the evaluation result generated by the server 10. The message 307 may list the text that the user mispronounced (i.e., the wrong content different from the guidance information).

In one embodiment, the evaluation module 12 (of the service account) can generate second guidance information according to at least one of the text and the pronunciation of the wrong content. The second guidance information is also a text for the user to pronounce. The initial guidance information may be pre-defined content without personal adjustment, while the second guidance information is generated by actually analyzing the pronunciation of the user (i.e., with personal adjustment). For example, the wrong content is related to retroflex consonants “ [symbol] ” and “ [symbol] ” (such as the different pronunciation of consonant “s” in “books” and “words” in English), and then the second guidance information can be a tongue twister that contains a lot of consonants “ [symbol] ” and “ [symbol] ” (such as “sleeps, books, hats”, “Crabs, words, bags” in equivalent English exercises) to strengthen the effect of pronunciation exercises on these voices. The processor 57 (of the user account) can receive the second guidance information through the social communication program 52 and through the communication transceiver 55 and display the second guidance information through the display 59. In some embodiments, the second guidance information can also be accompanied by a recording (which may include related instructions) corresponding to its text content for the user to listen to and refer to. The recording of the second guidance information can be pre-recorded by a real person or generated by the text-to-speech (TTS) technology of the server 10 or the user device 50.

Similarly, the processor 57 (of the user account) can record the voice content pronounced by the user according to the second guidance information, the voice content pronounced by the user is converted into a second text to be evaluated through the voice input engine 53, and the second text to be evaluated according to the second guidance information is transmitted to the server 10 through the communication transceiver 55. Moreover, the evaluation module 12 can also compare the second guidance information with the second text to be evaluated to generate a corresponding evaluation result or other guidance information. Note that the evaluation result and the guidance information can be generated repeatedly but not in a specific order, and the guidance information may be generated according to any one or more than one of the previous wrong content. By repeatedly practicing the wrong content, the frequency of the mispronunciation of the user can be reduced, and the accuracy of the pronunciation and communication efficiency of the user can be further improved.

In one embodiment, the processor 57 (of the user account) can also input preliminary messages through voice input. This preliminary content is the text content that the user of a user account wants to send to other user accounts (e.g., relatives, friends, colleagues, etc.) of the social communication program 52, and the user does not need to pronounce it according to the guidance information. The user account can directly transmit the pronounced preliminary message to the service account through a third text to be evaluated converted by the voice input engine. The processor 57 (of the service account) can correct the wrong content in the third text to be evaluated according to the evaluation result to form a final message. For example, if the evaluation result is that the consonant “ [symbol] ” is recognized as the consonant “ [symbol] ” (the consonant “d” in English is recognized as “t”), the processor 57 can further determine whether words with the consonant “ [symbol] ” (consonant “d” in English) in the third text to be evaluated should be corrected to words with the consonant “ [symbol] ” (consonant “t” in English). Moreover, the processor 57 may select an appropriate word according to the corrected word and the context. For example, when the next word after the word to be corrected is pronounced “area”, the processor 51 may select “land” as the corrected word instead of “lend”. The final message is the corrected message of the wrong content in the preliminary message, and the final message can be sent by the user account in the social communication program 52 and through the communication transceiver 55. In other words, the service account can correct the wrong content according to the past speech content of the user of the user account automatically without manual adjustment of the user.

Moreover, the embodiment of the disclosure is imported into the social communication program 52, and the robot provided by the server 10 can be any one or more than one of the friends or accounts (i.e., service accounts) that the user selects. The social communication program 52 is widely used software (i.e., software downloaded by most users themselves or pre-installed on the user device 50), so any user can easily use the voice input analysis and correction function of the embodiment of the disclosure.

In summary, with the pronunciation teaching method of the embodiment of the disclosure, the wrong content of a voice input of a user can be analyzed on the platform provided by the social communication program, accordingly an evaluation result is provided, and the evaluation result is even provided for the correction of subsequent voice content. Therefore, the embodiment of the disclosure has characteristics as follows. The embodiment of the disclosure can assist in the development of correct pronunciation, so people can pronounce accurately to be understood, thereby increasing the communicative competence. The embodiment of the disclosure can assist in the development of correct pronunciation, so the system of the user device can correctly understand the content of the voice input, thereby increasing the efficiency of the voice input and reducing the correction time. The embodiment of the disclosure requires no real humans involved to listen to the speech of a user and can determine the wrong content of a voice input with the same standard to generate subsequent teaching content (the hearing of different real humans is different). The embodiment of the disclosure is applicable to different language learning. Moreover, as long as the user device can access the Internet, users can learn at anytime and anywhere.

Although the disclosure has been described with reference to the above embodiments, it will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A pronunciation teaching method, comprising:
providing a service account in a social communication program, wherein the social communication program provides reception and transmission of text messages, and the service account provides a pronunciation teaching program, wherein the pronunciation teaching program comprises:
providing guidance information to a plurality of user accounts of the social communication program through the service account, wherein the guidance information is a text provided for users of the user accounts to pronounce;
inputting the guidance information by voice input through the user accounts and directly transmitting a text to be evaluated converted from the pronounced guidance information through a voice input engine to the service account; and
providing an evaluation result to a corresponding user account according to the text to be evaluated through the service account, wherein the evaluation result is related to a difference between the guidance information and the text to be evaluated.

2. The pronunciation teaching method according to claim 1, wherein after the step of transmitting the text to be evaluated, the method further comprises:
comparing the guidance information and the text to be evaluated through the service account to obtain wrong content in the text to be evaluated, wherein the wrong content is the difference between the guidance information and the text to be evaluated.

3. The pronunciation teaching method according to claim 2, wherein after the step of obtaining the wrong content in the text to be evaluated, the method further comprises:
generating the evaluation result according to at least one of a text and a pronunciation of the wrong content through the service account, wherein the evaluation result comprises a statistical result of the text or the pronunciation of the wrong content.

4. The pronunciation teaching method according to claim 2, wherein after the step of obtaining the wrong content in the text to be evaluated, the method further comprises:
generating second guidance information according to at least one of a text and a pronunciation of the wrong content through the service account and transmitting the second guidance information to a corresponding user account, wherein the second guidance information is a text provided for the users of the user accounts to pronounce.

5. The pronunciation teaching method according to claim 1, wherein after the step of providing the evaluation result, the method further comprises:
inputting a preliminary message by voice input through a user account and directly transmitting a second text to be evaluated converted from the pronounced preliminary message by the voice input engine to the service account, wherein the preliminary message is text content that the user account wants to send to another user account; and
correcting the wrong content in the second text to be evaluated according to the evaluation result through the service account to form a final message and providing the final message to a corresponding user account, wherein the final message is a corrected message of the wrong content in the preliminary message and is provided to the corresponding user account for operation.

6. The pronunciation teaching method according to claim 1, wherein the step of providing the guidance information comprises:
transmitting the guidance information through the social communication program by the service account.

7. The pronunciation teaching method according to claim 1, wherein the step of providing the guidance information comprises:
transmitting an identification code corresponding to the guidance information through the social communication program by the service account; and
obtaining the guidance information by the user accounts according to the identification code.
